(19) United States
(12) Patent Application Publication
(10) Pub. No.: US 2013/0255340 A1
(43) Pub. Date: Oct. 3, 2013

(54) Delignification of biomass containing lignin and production of long lasting lignin fertilizer

(71) Applicant: David H. Blount, San Diego, CA (US)

(72) Inventor: David H. Blount, San Diego, CA (US)

(21) Appl. No.: 13/506,193

(22) Filed: Apr. 2, 2012

(51) Int. Cl. C05F 11/00; C08H 7/00

(52) U.S. Cl. 71/23; 530/505; 530/500

(57) ABSTRACT

A new fertilizer comprising of amino lignin compounds, which are made by delignification of biomass containing lignin utilizing amino compounds and producing amino lignin, amino lignincellulose and cellulose. The urea lignincellulose is reacted with potassium hydroxide to produce potassium salt of amino lignin and lignincelluose. The amino lignin is reacted with phosphorous acid to produce an amino lignin phosphorous acid. These amino lignin compounds reacted with potassium and phosphorous acid are the source nitrogen, potassium and phosphorus in the new solid or aqueous fertilizer.

### PRIORITY CLAIM

This application claims priority to U.S. Provisional application Ser. No. 12/589,399 filed Oct. 23, 2009

### FIELD

The invention relates to new chemical compositions of matter having utility as industrial chemicals, fertilizers, and, fungicides. This invention particularly relates to products produced by the delignification of biomass containing lignin utilizing amino compounds and is a continuation-in-part of U.S. patent application Ser. No. 13/385,150 filed Feb. 6, 2012 and U.S. patent application Ser. No. 12/589,399 filed Oct. 23, 2009.

The invention concerns the production of long acting fertilizer urea and other amino compounds utilized in an aqueous solution to break the lignin cellulose bond and react the amino compound with the lignin and with the lignin attached to the cellulose to produce amino lignin and amino lignincellulose. An amino compound is mixed with a lignin containing plants in water at ambient temperature or heated. The aqueous solution containing preferred amino compound that will break the lignin cellulose bond, such as urea and guanidine compounds, and lignin containing plant is placed in amino water solution for 12-24 hours or is heated at 50 to 150 degree C. for 1-24 hours at ambient pressure or elevated pressure. The lignin reacts with the delignification amino compounds to form amino lignin which is soluble in water and the amino compounds reacts with lignin that is still attached to the cellulose to produce amino lignincellulose which is non-water soluble. The water containing the amino lignin is filtered from the proportioners, and irrigation lines. This has been a limitation with water-soluble fertilizer and fungicide formulations commercially available.

The urea lignin compounds are inexpensive to produce especially when produced by pulp producers or ethanol producers because they can produce the amino lignin first and use the lignin which is usually wasted or burned then use the cellulose for paper and ethanol production. The amino lignin may also be used to produce adhesives and resins.

The use of urea aldehyde resins containing lignin sulfonate is well know in the Art but the use of amino compounds such as urea, guanidine, cyanoguanidine, amino guanidine, guanidine carbonates and mixtures thereof for delignification of lignin from biomass consisting of lignin containing plants and at the same time reacting the amino compound with lignin and with lignin still attached to the cellulose is novel before reacting the amino compound with an aldehyde. There are many US and Foreign Patents which utilized urea formaldehyde resin containing lignin sulfonate and other extracted lignin but no articles or patents were found that produces amino salt of lignin in the process of delignification of plants containing lignin. U.S. Pat. No. 2,366,265 of Reiche et al. and U.S. Pat. No. 2,622,979 of Keim extends the urea formaldehyde resin by the addition of lignin-sulfonate. U.S. Pat. No. 3,994,860 of Willegger and Thiel adds the lignin sulfonate to the formaldehyde and urea to produce a resin. The use of aminoplasts as an adhesive and resin is well known in the art but an aqueous solution of the aminoplasts such as urea formaldehyde resin does not have any properties to break the lignin cellulose bond. Unlike the prior art processes of these representative patents, in accordance with this invention most of the lignin and cellulose bonds are broken by the amino lignincellulose and lignincellulose. The aqueous solution of the amino lignin is dried. The amino lignincellulose is reacted with potassium hydroxide in an aqueous solution to produce water soluble potassium amino lignin which is filtered from the lignincellulose and cellulose then dried.

### BACKGROUND OF THE INVENTION

### Description of Relevant Art

In greenhouses, nurseries, and, gardens, or other intensive horticulture environments, best results are attained when fertilizers and pesticides are carefully delivered to the soil or growing plants. Many growers choose to utilize blended high analysis water-soluble fertilizers and fungicides. These fertilizers and fungicides are marketed as liquids or solids, which are dissolved or diluted, to prepare concentrated stock solutions; these fertilizer/fungicide solutions may again then be diluted by irrigation water by means of proportional or injection devices.

In agriculture most excellent results are also achieved when fertilizers and pesticides are carefully delivered to the soil or growing plants. Many growers choose to utilize blended high analysis water-soluble fertilizers and fungicides. These fertilizers and fungicides are marketed either as solids or liquids; the fertilizers and/or fungicides are dissolved in spray tanks for foliar applications, or are used to prepare concentrated stock solutions for ground application.

It is also desired that a fertilizer and fungicide formulations have good long-term stability as stock solutions so as not to form precipitates, which can clog spray rigs, amino compound and the amino reacts with the lignin to produce amino lignin and amino lignincellulose.

This invention concerns new fertilizer and/or fungicide compositions; I have found liquid and solid fertilizer and fungicide compositions useful for preparing aqueous solutions and fertilizer solids for plant nutrition and plant fungicides. Often time's fertilizer and fungicides are used with buffers. The buffering prevents the alkaline hydrolysis of insecticides, fungicides, and herbicides, therefore, insuring greater efficacy to their pesticide applications. Urea lignin phosphorous acid will serve as an excellent low pH buffer, thereby protecting the applicator's pesticide investment.

The reaction product of the present invention, most preferably urea lignin, urea lignincellulose, potassium salt of urea lignin and amino lignin phosphorous acid, will be found to produce enhanced growth in plants when used in a variety of ways. The reaction products urea lignin, urea lignincellulose, potassium salt of urea lignin and urea lignin phosphorous acid will produce enhanced growth when applied to seeds or soil prior to or at planting, when applied to the soil surrounding the plant at or after planting or when applied to the foliage of the plant. Alternatively, a solution or dry matter of urea lignin, urea lignincellulose, potassium salt of amino lignin and urea lignin phosphorous acid may be applied to the soil surrounding the seed and/or emerging plant. All application methods will deliver fertilization and fungal protection.

Solutions containing mineral salts or non-chelated micronutrient trace metals, such as: calcium, magnesium, cobalt, iron, manganese, copper, boron, zinc and molybdenum, may be made available to the plant by dissolving them completely in water. When applying urea lignin to foliage, those skilled in the art may include a conventional admix in the solution to improve the retention of reaction product on the leaves so that the plant may more readily absorb it. In one embodiment, this invention provides a mineral salts-containing solid complex fertilizer and fungicide, which dissolves completely in water to give a water-based precipitate-free, stable aqueous stock solution. A liquid fertilizer and/or fungicide containing amino lignin, potassium salt of amino lignin and amino lignin phosphorous salts will provide phosphorus, potassium and nitrogen source for plant protection and nutrition.

In another embodiment, this invention provides a trace metal-containing solid blended fertilizer and/or fungicide that dissolve completely in water to give a water-based, precipitate free, stable aqueous stock solution. Trace metals are also produced from plants in the delignification of plants with amino compounds.

In another embodiment, this invention provides a fertilizer and/or fungicide containing urea lignin phosphorous acid as a phosphorus source and chelated, partially chelated, complexed, or non-chelated micronutrient trace metal nitrates, chlorides, carbonates, oxides or sulfate salts. This material may contain magnesium and/or calcium as well. It also may contain any mineral salt. For aqueous stock solutions this method involves blending or adding a fertilizer and fungicide admix to amino lignin. For blended liquid and solid fertilizer and fungicide products this method includes compounding or blending admix with the liquid urea lignin. These same general processes can be used to prepare a non-chelated mineral salt blended with the urea lignin containing fertilizer and fungicide.

The inclusion of urea lignin in a dry blended mixture of nutrient sources which include calcium salts, and/or magnesium, with or without trace metals such as iron and the like in non-chelated forms such as nitrates and/or sulfates offers several advantages. For one, the urea lignin phosphorous acid establishes a low pH condition when blended mixture is added to water to make a concentrated stock solution. A stock solution pH in the range of 0 to 2 may be achieved. This low solution pH maintains solubility and clarity of the concentrated stock solution.

In another embodiment, this invention provides a trace metal-containing solid blended fertilizer and/or fungicide that are completely soluble in water to give a water-based, precipitate free, stable aqueous stock solution.

In another embodiment, this invention provides a fertilizer and/or fungicide containing amino lignin phosphorous salt as a phosphorus source and chelated, partially chelated, complexed, or non-chelated micronutrient trace metal nitrates, chlorides, carbonates, oxides or sulfate salts. This material may contain magnesium and/or calcium as well. It also may contain any mineral salt.

In still another embodiment, this invention provides a method for preparing a stable phosphorus-containing fertilizer and fungicide with admix. Please see the text below for the Discussion of Possible Admixes. For aqueous stock solutions this method involves blending or adding a fertilizer and fungicide admix to urea lignin. For blended liquid and solid fertilizer and fungicide products this method includes compounding or blending admix with the liquid urea lignin. These same general processes can be used to prepare a non-chelated mineral salt blended with the urea lignin containing fertilizer and fungicide.

The inclusion of amino lignin phosphorous salts in a dry blended mixture of nutrient sources which include calcium salts, and/or magnesium, with or without trace metals such as iron and the like in non-chelated forms such as nitrates and/or sulfates offers several advantages. Therefore, when urea lignin phosphorous acid is used as a phosphorus source, it will make possible the inclusion of phosphorus and the mineral salts in one compound fertilizer and/or fungicide, without the use of chelates, or the disadvantage of a precipitate forming.

This allows the end user to prepare and apply a complete fungicidal and/or nutrient solution using one stock solution and utilizing one injector. It also makes possible the inclusion of non-chelated trace nutrients into phosphorous-containing nutrient solutions without precipitation. It also allows the fertilizer and fungicide solution to have an increased acidifying effect on the growing medium if needed. In summary, the advantages of using urea lignin phosphorous acid as a phosphorus source in a compound fertilizer and/or fungicide are: The ability to purchase, prepare and apply a complete fungicidal and/or nutrient solution with one stock solution. The ability to use non-chelated mineral salts without a reduction in solubility in the stock solution as is observed using conventional dry phosphorus sources. The ability to formulate acidic fertilizer and/or fungicides that are sold as dry solids or liquids and thus are less hazardous to the end user than liquid phosphoric acid-based materials.

In order to improve the free-flowing properties of the urea lignin, potassium salt of urea lignin and urea lignin phosphorous acid liquid, a common anti-caking agent such as amorphous silica, bentonite, flour, etc., may be added. The amount of the anti-caking agent is in the usual range utilized for this purpose such as between 1.50-3% by weight.

The process is very simple to carry out; after mixing phosphorous acid with the urea lignin, the reaction system may be heated in view of the endothermic reaction, which takes place. The reaction is accomplished once the blend is clear and liquid urea phosphorous acid formed in the reaction vessel is ready for use without any further operation. Higher P or N assays can be achieved by the addition of phosphorus sources or various nitrogen sources, such as urea, ammonium, or, nitrate sources. In cases where amino lignin phosphorous acid is not the sole phosphorus source, other phosphates such as potassium phosphates' and ammonium phosphates' can make up the balance. In addition to phosphorus, nitrogen content the blend may include potassium.

In another embodiment, this invention provides a trace metal-containing solid blended fertilizer and/or fungicide that is completely soluble in water to give a water-based, precipitate free, stable aqueous stock solution.

The fertilizer and fungicide compositions of this invention contain urea lignin phosphorous acid. The amount of urea lignin phosphorous acid will vary depending upon the nitrogen and phosphorous analysis desired for the formulated composition. Typically, the urea lignin phosphorous acid is used with an Admix—this includes other nutrient sources. Since urea lignin phosphorous acid contributes nitrogen as well as phosphorus in a stoichiometric ratio to the fertilizer and fungicide mix it may be necessary to add additional potassium, phosphorus, and nitrogen sources to alter the ratio provided by urea lignin phosphorous acid alone.

The molar ratios between the urea lignin and phosphorous acid are between 3:1 and 1:2; an excess of either material may be present without interfering in the direct preparation of the liquid urea lignin and urea lignin phosphorous acid. Of course, any suitable mixer system can be used and it is not necessary that the mixing be done simultaneously with the onward conveying; the reactants may dwell in the mixer for a time and the entire product then be discharged from the mixer at once. In order to improve the free-flowing properties of the urea lignin and urea lignin phosphorous acid liquid, a common anti-caking agent such as amorphous silica, bentonite, flour, etc., may be added. The amount of the anti-caking agent is in the usual range utilized for this purpose such as between 1.50-3% by weight.

The process is very simple to carry out; after mixing phosphorous acid with the urea lignin, the reaction system may be heated in view of the endothermic reaction, which takes place. The reaction is accomplished once the blend is clear and liquid urea lignin phosphorous acid formed in the reaction vessel is ready for use without any further operation.

When the urea lignin and urea lignin phosphorous acid are for fertilizer or fungicide use, desired micronutrients such as Mg, Co, Fe, Zn, Cu, Mn, etc., may be incorporated in the initial phosphorous acid prior to the reaction with the solid urea without interfering with the course of reaction. This is an additional advantage where a reliable dosage of micronutrients is not possible.

If desired to obtain compounds with a higher ratio of N:P or N:P:K for fertilizers, the urea lignin, potassium salt of urea lignin and urea lignin phosphorous acid may be transformed into prills by an admix. It can also be used in various compound fertilizers. A solid product of the invention may contain about 0.02% by weight (total solids) of urea lignin phosphorous acid that, by itself, will contribute about 0.008% weight phosphorous as P.sub.2O.sub.5, and about 0.003% weight nitrogen as N. The liquid product can contain up to about 100% by weight of urea lignin phosphorous acid that would by itself contribute about 30% weight phosphorus as P.sub.2O.sub.5 and about 15% weight nitrogen as N. Higher P or N assays can be achieved by the addition of phosphorus sources or various nitrogen sources, such as urea, ammonium, or, nitrate sources. In cases where urea lignin phosphorous acid is not the sole phosphorus source, other phosphates such as potassium phosphates' and ammonium phosphates' can make up the balance. In addition to the phosphorous and nitrogen content the blend may include potassium. Similarly, it may be advantageous to include admix discussed below.

### SUMMARY

### Amino Lignin Compound Production;

In one aspect, the invention comprises the delignification of biomass consisting of lignin containing plants by an amino compound such as urea and/or guanidine compounds in an aqueous solution thereby producing amino salt of lignin and amino-lignin-cellulose, hemi-cellulose, cellulose, carbohydrates and trace metals.

Another aspect of the invention is a method to react the amino compound with the lignin to form an aqueous amino lignin solution which is then filtered from the amino lignincellulose, lignincellulose and cellulose.

Another aspect of the invention is to not separate the amino lignincellulose, hemi-cellulose, carbohydrates, trace metals and amino lignin.

Another aspect of the invention is to react the amino lignincellulose with potassium hydroxide to produce potassium salt of amino lignin and lignincellulose and cellulose.

Another aspect of the invention is to react the amino lignin with a phosphorous acid compound to produce amino lignin phosphorous compound.

### Component A

Amino Compounds such urea, guanidine, aminoguanidine, guanidine carbonate, cyanoguanidine and mixtures thereof are utilized to break the lignin cellulose bond and amino compounds are react with the lignin and with the lignin attach to the cellulose but has free acid radicals. The amino compounds may be in the form of a powder, crystals or a solid. Any suitable amino compound may be utilized with the urea and/or guanidine compounds to reach with the lignin such as melamine, dicyandiamide, melamine cyanurate, thiourea, methyl urea, biuret, cyanuric acid, urea condensates such as urea guanidine condensates, urea polyamine condensates, cyamelide, urea-melamine condensates, urea-cyandiamide, urea-aminoguanidine condensate, urea cyanoguanidine condensate, urea cyanurate, aminophosphates with free —NH₂ radicals and mixtures thereof. Urea is the preferred amino compound and maybe in any suitable form such as prills, crystals, or diluted liquids. The amino compounds are utilized in the amount of 25-100 parts by weight. Urea, being approximately 46% by weight nitrogen, has long been preferred as a nitrogen source for fertilizing soils to stimulate plant growth. Phosphorous acid, being approximately 86.5% by weight P.sub.2O.sub.5, and its salts, have been used as a fungicide and a fertilizer.

### Component B

Any suitable biomass consisting of lignin containing plant may be used in this invention. Any suitable biomass consisting of lignin-cellulose or cellulose-containing plants or the products of cellulose containing plants which contain lignin and cellulose may be used in this invention. Many different biomass feed stocks can be used to produce fertilizer, resins, plastics or liquid fuel. Some of the common ones are agricultural crops, bio-energy crops, such as fast growing trees, agricultural residues, wood residues and waste streams from municipal solid waste cellulose fiber fines, baggasse and waste paper. The plant material is preferred to be in the form of small particles such as sawdust, wood chips or ground up biomass. In nature, lignin-cellulose and cellulose are widely distributed. It is found in all plants and they may be used in this process. Suitable cellulose-containing plants include, but are not limited to, trees, e.g., spruce, pine, hemlock, fir, oak, cypress, redwood, cherry, elm chestnut, hickory, locust, sycamore, tulip, tulip, butternut, apple, alder, magnolia, dogwood, catalpa, boxwood. Crabwood, mahogany, greenheart, lancewood, letterwood, mora, prima vera, purple-heart, rosewood, teak, satinwood, mangrove, waffle, orange, lemon, logwood, fustic, osage orange, sappanwood, Brazilwood, barwood, camwood, sandalwood, rubber, gutta, mesquite and shrubs, e.g., oleander, cypress, junipers, acanthus, pyracantha, ligustrum, lantana, bougainvillea, azalea, feijoa, ilex, fuscia, hibiscus, datura, holly, hydrangea, jasmine, eucalyptus, cottoneaster, xylosma, rhododendron, castor gean, eugenia, euonymus, fatshedera, aralia, etc., and agricultural plants e.g., cotton stalks, corn stalks, wheat straw, oat straw, rice straw, cane sugar (baggasse) soybean stalks, peanut plants, pea vines, sugar beat waste, sorghum stalks, tobacco stalks, maize stalks, barley straw, buckwheat straw, quinoa stalks, cassava, potato plants, legume vines and stalks, vegetable inedible portion, etc., weeds grasses, vines, kelp, flowers and mixtures thereof. The waste products of agricultural plants which contain cellulose and lignin may be ground into small particles and used in this invention. Commercial waste products containing lignin and cellulose, e.g., paper, baggasse wallboard, wood products, etc., may be used in this invention. Cellulose-lignin containing plants which have been partially decomposed, such as grass clippings, humus, peat and certain soft brown coal, may be used in this invention.

Other products of cellulose lignin containing plants may be recovered in the process of this invention such as waxes, gums, oils, sugars, wood alcohol, agar, rosin, turpentine, resins, rubber latex, dyes, glycerol, trace metals, etc. Lignin containing plants are utilized in the amount of 200 to 400 parts by weight.

### Component C

Water is utilized to make and aqueous solution of the amino compounds and also to wash out the water soluble components such as amino salt of lignin from the amino-lignin-cellulose in the amount of 1-500 parts by weight.

### Component D

Any suitable aldehyde may be utilized in this invention that will react with the amino lignin or the amino lignincellulose. Suitable aldehyde include but not limited to, formaldehyde, paraformaldehyde, acetoaldehyde, butyaldehyde, chloral, acrolin aldehyde and other aromatic aldehydes, furfural, benzyl aldehyde and mixtures thereof. Aqueous formaldehyde is the preferred aldehyde. The aldehyde is used in the ratio of 1 mol of amino compound to 1 to 3 moles of aldehyde.

### Component E

Any suitable filler may be added to the long acting fertilizer such as urea, amino salt of lignin aldehyde resin or amino lignincellulose resin. They may be inorganic substance, such as, alkali metal silicates, alkaline earth metal silicates, metal silicates, silica, metals and metal oxides, sulphates, phosphates, borates, glass beads, potassium salts and mixtures thereof. They may be organic substances such as, amino compounds, wood particles, cellulose, lignin, urea formaldehyde resin, amino salts of organic phosphates, amino aldehyde resins, plastics, powdered coke, graphite, graphite compounds, plant particles and mixtures thereof. The filler may be used in the amount of 1 to 300 parts by weight.

### Component F

Any suitable method may be used to convert the amino lignincellulose and remaining cellulose into carbohydrates such as the dilute and/or the concentrated acid hydrolysis methods using sulfuric acid or hydrochloric acid. The concentrated acid utilized in the amount of 2 to 3 parts by weight of acid to 2 parts by weight of amino lignincellulose

### ILLUSTRATIVE EMBODIMENTS

In general, the lignin cellulose bond is broken by soak in an aqueous solution of the listed amino compounds at ambient temperature for 12 to 24 hours or by heating the biomass containing lignin cellulose plant particles in an aqueous solution of listed amino compounds at ambient pressure at 100 degree C. for 1-4 hours or at 150 degree C. under pressure for 0.5 to 4 hours thereby breaking the lignin cellulose bond and the amino compounds reacts with the lignin to form amino salt of lignin and the amino compound react with the lignin still attached to the cellulose to produce amino lignincellulose. The amino lignin is water soluble. The aqueous amino lignin solution is removed from the amino lignincellulose by compression, filtration or any suitable means maybe utilized as an aqueous solution or dried. The amino lignincellulose has many uses such as paper production, hydrolyzed to carbohydrates, fiberboard, plywood, molded objects, fertilizer, animal feed and other uses. A basic catalyst may be added to the amino lignin and amino lignincellulose mixture to produce the desired pH.

The amino lignincellulose, hemi-cellulose, lignin cellulose and cellulose produced by this invention are hydrolyzed to carbohydrates by acid hydrolysis using 70% sulfuric acid or 40% hydrochloric acid. The concentrated acid is add to the dried amino-lignin-cellulose in the ratio of 1-2 parts by weight of acid to 1 part weight of the amino-lignin-cellulose then heated to a low temperature of 50-70 degree C. for 1-6 hours to produce a mixture of carbohydrates, amino salt of the acid, lignincellulose and cellulose. The cellulose and lignin cellulose that was not hydrolyzed is separated by pressing and filtering then retreated by re-acting the lignin with an amino compound in an aqueous solution to produce a water soluble amino salt of lignin which is removed from the cellulose by pressing and filtering. The cellulose is then dried and retreated with the acid. The aqueous solution of carbohydrates and sulfuric acid are treated to separate the carbohydrates from the sulfuric acid by via ion exchange and then the sulfuric acid is re-concentrated via multiple effect evaporators. When hydrochloric acid is utilized the remaining solid cellulose and lignin cellulose are removed from the aqueous solution of carbohydrates and amino chloride by pressing and filtering then retreated. The carbohydrates and amino chloride is recovered by evaporating the aqueous hydrochloric acid under vacuum to depress the boiling point. The acid left in the carbohydrate and amino chloride is naturalized with calcium hydroxide. The amino lignincellulose, hemi-cellulose, lignincellulose, cellulose may be hydrolyzed by cellulase and bacterial enzymes. The carbohydrate may be converted into alcohol by yeast or any other suitable means.

A dilute acid hydrolysis process using sulfuric or hydrochloric acid may be utilized to hydrolyze the amino lignincellulose into carbohydrates. The amino lignin-cellulose is soaked in 30-40% sulfuric or hydrochloric acid for 1-4 hours then water is evaporated until the acid is more concentrated up to 40 to 70% then further reacted for 1-4 hours. The carbohydrates, acid and amino salt is filter by pressing or filtering and the cellulose and lignin cellulose residue is retreated.

The amino salt of lignin and amino-lignin-cellulose may be used as fertilizer, as animal feed, as an adhesive and used in the production of paper, resins and plastics. The amino lignincellulose may also be hydrolyzed into carbohydrates to be used in the production of food, alcohols and other products.

The following examples illustrate the amino lignin compounds for use as fertilizer. Unless otherwise designated, all constituents are designated on the basis of parts by weight.

### Example 1

40 parts by weight of soft wood sawdust and 15 parts by weight of urea were added to 150 parts by weight of water then the mixture was heated to the boiling point of water at ambient pressure for 1 hour. The water had a brown color after 5 minutes of heating. The remaining aqueous urea lignin solution was pressed and filtered from the non-water soluble urea lignincellulose then the urea lignincellulose and was washed with water pressed and filtered to remove more aqueous urea salt of lignin. The urea lignincellulose is dried, weighed and has lost 25% of the softwood's original weight. The urea lignincellulose is dried and utilized as a dry fertilizer. The aqueous urea lignin is utilized as a liquid, long lasting, fertilizer or maybe spray dried and used as a dry fertilizer.

### Example 2

20 parts by weight of guanidine was added to 80 parts by weight of fir sawdust then 250 parts by weight of water was added, mixed, after 12′ hours, the dark brown guanidine lignin aqueous solution was removed by pressing and filter from the guanidine lignincellulose. The guanidine lignincellulose was dried and weighed. There was a 15% weight loss from the fir sawdust. The guanidine lignincellulose is used as a dry, long lasting, fertilizer.

### Example 3

30 parts by weight of urea and 70 parts by weight of fir sawdust was mixed in 300 parts by weight of water then boiled for 1 hour. The dark brown aqueous solution of urea salt of lignin was filtered and pressed from the urea lignincellulose. The urea lignin-cellulose was washed then pressed and filtered to remove more of the urea lignin. The urea lignincellulose was dried for further use and weighed 70% of the original fir sawdust. The urea lignincellulose was heated to evaporate the water until the aqueous urea lignin became a thick paste then 50 parts by weight of fir sawdust and formaldehyde in the ratio of 1 moles of formaldehyde for each mol of urea was mixed. The mixture was heated while agitating until the water was removed then the mixture was ground into small granules to produce a dry long lasting fertilizer.

### Example 4

About 50 parts by weight of mixed soft wood and 30 parts by weight of urea are added to 150 parts by weight of water, mixed, heated while agitating for about 1 hour. The aqueous solution of urea lignin and the solid urea lignincellulose are heated to remove most of the water then about 1 moles of aldehyde is add for each mol of urea, then 20 parts by weight of fir sawdust is added and mixed. The pH of the mixture is 5. The mixture is heated to remove most of the water then the mixture is ground into small granules and dried to produce a dry long lasting fertilizer.

### Example 5

Example 4 is modified wherein the aqueous urea lignin formaldehyde and urea lignincellulose formaldehyde are emulsified to produce an emulsified long lasting fertilizer.

### Example 6

30 parts by weight of urea is mixed with 70 parts by weight of pine sawdust then added to 200 parts by weight of water. The mixture was heated under pressure to about 125 degree C. for about 1 hour thereby producing a mixture of urea lignin and urea lignincellulose and lignincellulose. The aqueous solution containing the urea lignin was removed from the urea lignincellulose by pressing and filtering. 10 parts by weight of potassium hydroxide and 100 parts by weight of water were added to the urea lignincellulose and lignincellulose then heated to just below the boiling point of water for 1 hour thereby producing an aqueous solution of potassium salt of urea lignin for use as an aqueous fertilizer. The aqueous urea lignin and potassium salt of urea lignin are mixed to produce a long lasting fertilizer.

### Example 7

Example 6 is modified wherein 10 parts by weight of an amino compound selected from the list below is added to the mixture of urea lignin and urea lignincellulose.

| | |
|---|---|
| A) melamine | B) dicyandiamide |
| C) guanidine | D) biuret |
| E) cyanuric acid | F) cyamelide |
| G) melamine cyanurate | H) urea melamine condensate |
| I) Urea guanidine | J) guanidine carbonate |
| K) cyanoguanidine | L) aminoguanidine |
| M) dimelamine phosphate | N) diurea phosphate |

### Example 8

10 parts by weight of urea and 30 parts by weight of biomass containing lignin containing plants listed below is ground and mixed with 100 parts by weight of water then heated in an autoclave at 150 degrees C. under 100 psig of pressure for 30 minutes. The mixture was cooled and then the mixture was pressed and filtered to remove the water soluble urea lignin from the solid urea lignincellulose and lignincellulose. The solid material was re-washed several times to remove more urea lignin. The urea lignin-cellulose and lignincellulose was dried, ground into small particles and used as dry long lasting fertilizer. The aqueous amino lignin is utilized as a long acting aqueous fertilizer.

| | |
|---|---|
| A) fir sawdust | B) aspen sawdust |
| C) aspen thin chips | D) Pine sawdust |
| E) sycamore sawdust | F) popular thin chips |
| G) oleander granules | H) eucalyptus sawdust |
| | J) cotton stalk grindings |
| K) corn stalks grindings | L) switch grass choppings |
| M) baggasse grindings | N) grass clippings |
| O) peat grindings | P) humus particles |
| Q) cardboard particles | R) baggasse wallboard particles |
| S) grape vines particles | T) rice straw grindings |
| U) wheat straw grinding | V) buck wheat straw grindings |
| W) sorghum stalks grindings | X) soybean stalk grindings |

### Example 9

Example 8 is modified wherein the urea lignincellulose and lignincellulose produced by the method of example 8 is added to 75% sulfuric acid in the ratio of 2.5 parts by weight of acid to 2 parts by weight of the urea-lignin-cellulose and heated to about 50 degree C. for 2-3 hours then add water to dilute the acid to a concentration of 25% and heat at 100 degrees C. for an hour. The carbohydrates, urea sulfate, lignin cellulose and cellulose from the reactor is pressed and filtered to recover the carbohydrate and acid. The acid and carbohydrates are separated by ionic exchange. The acid is re-concentrated via multiple effect evaporators. The remaining cellulose and lignincellulose are retreated again with the sulfuric acid.

### Example 10

Example 8 is modified wherein the urea lignincellulose and lignincellulose produced by the method of example 8 is added to 40% HCl in water in the ratio of 3 parts by weight of the acid to 2 parts by weight of the urea lignincellulose then heated to about 60 degree C. for 3 hours. The hydrochloric acid is separated from the carbohydrates and remaining lignin cellulose and cellulose, urea salt of hydrochloric acid and lignin via vacuum distillation. The remaining cellulose and lignin is heated with aqueous urea to produce urea salt of lignin then filtered from the cellulose. The cellulose and lignin cellulose are retreated again with hydrochloric acid. The remaining HCl in the carbohydrate solution is naturalized with calcium hydroxide.

### Example 11

Cardboard was cut into small pieces then wash with water and pressed to remove excess water. 20 parts by weight of cardboard and 10 parts by weight of urea was added to 70 parts by weight of water then heated to the boiling point of water for two hour. The non-water soluble amino lignincellulose and lignincellulose were pressed and filtered to remove the dark water soluble amino lignin. The amino lignin was dried and weighed 8 parts by weight and the dried solid amino lignincellulose and lignincellulose weighed 21 parts by weight. The aqueous urea lignin is spray dried then mixed with the amino lignincellulose and lignincellulose to produce a dry long lasting fertilizer.

### Example 12

Example 8 is modified wherein the aqueous amino lignin is mixed with 3 parts by weight of potassium hydroxide and heated to just below the boiling point of water for 1 hour thereby producing potassium salt of amino lignin to produce an aqueous fertilizer. The aqueous potassium salt of amino lignin may also be spray dried to produce a dry fertilizer.

### Example 13

Example 2 is modified wherein another amino compound is used in place of guanide and selected from the list below:

| | |
|---|---|
| a) guanidincarbonate | b) aminoguandine |
| c) cyanoguanidine | d) urea guanidine condensate |
| e) aminoguanidine condensate | f) urea cyanoguanidine condensate |
| g) urea dicyandiamide condensate | h) diureaphosphate with free —NH₂ |

### Example 14

Example 2 is modified wherein the aqueous solution of guanidine lignin is reacted with 5 parts by weight of phosphoric acid thereby producing guanidine lignin phosphate to produce a fertilizer source of nitrogen and phosphorus.

### Example 15

50 parts by weight popular sawdust, 40 parts by weight of urea-guanidine condensate and 300 parts by weight of water are mixed then heated at about 100 degree C. for 2 hours while agitating. The aqueous solution of urea-guanidine lignin is filtered of from the urea-guanidine lignincellulose. The urea-guanidine lignincellulose is washed with water to remove more urea-guanidine lignin and then filtered. The aqueous urea-guanidine lignin is utilized as an aqueous long acting fertilizer and the urea-guanidine lignincellulose is utilized as a long lasting dry fertilizer.

### Example 16

10 parts by weight of urea lignin and 10 parts by weight phosphorous acid was added to 20 parts by weight of water then heated to the boiling point of water for 1 hour thereby producing an aqueous solution of urea lignin phosphorous acid. The aqueous solution of urea lignin phosphorous acid was spray dried to produce a dry fertilizer.

### Example 17

30 parts by weight of the dried urea lignin phosphorous acid produced in example 16, 10 parts by weight of dry amino lignin, 10 parts of dry amino lignincellulose and 10 parts by weight of potassium salt of urea lignin are ground into a course powder then mixed thereby producing a dry fertilizer.

### Example 18

20 parts by weight of the dried urea lignin phosphorous acid produced in example 16, 40 parts by weight of dry urea lignin and 10 parts by weight of dry potassium salt of urea lignin were added to 200 parts by weight of water thereby producing an aqueous fertilizer.

### Example 19

Example 16 was modified wherein 10 parts by weight of urea lignin and 10 parts by weight of phosphorous acid was heated until the phosphorous acid melted and then was allowed to react thereby producing urea lignin phosphorous acid thereby producing a dry fertilizer and is ground up into a course particles.

### Example 20

For a mole ratio of about 1:3 (phosphorous acid: urea lignin) 20 parts by weight of phosphorous acid and urea lignin were mixed the heated to 80 Degrees C. while stirring for 1 hour then water is added to produce and aqueous solution which has a fertilizer value of about 20% N and 50% P2O5.

### Example 21

Diammonium phosphate crystals and monopotassium phosphate crystals were mixed with the aqueous solution of urea lignin phosphorous acid produced in example 20 to produce a fertilizer.

### Example 22

20 parts by weight of the urea lignin phosphorous acid produce in Example 20, and 5 parts by weight of potassium hydroxide is added to 100 parts by weight of water to form an aqueous solution thereby producing an aqueous fertilizer.

### Discussion of Possible Components for Admixes:

For their practical application, the Urea lignin compounds according to this invention is rarely used on its own. Instead it generally forms part of formulations which also comprise a support and/or a surfactant in addition to active materials.

In the context of the invention, a support is an organic or mineral, natural or synthetic material with which the active material is associated to facilitate its application, for example, in the case of fertilizer and fungicides, to the plant, to seeds or to soil, or to facilitate its transportation or handling. The support can be solid (e.g, clays, natural or synthetic silicates, resins, waxes, solid fertilizer and fungicides) or fluid (e.g., water, alcohols, ketones, petroleum fractions, chlorinated hydrocarbons, liquefied gases, liquid fertilizer and fungicides). The surfactant can be an ionic or non-ionic emulsifier, dispersant or wetting agent, such as, for example, salts of polyacrylic acids and lignin-sulphonic acids, condensates of ethylene oxide with fatty alcohols, fatty acids or fatty amines.

The compositions comprising the compounds of the present invention can be prepared in the form of wettable powders, soluble powders, dusting powders, granulates, solutions, emulsifiable concentrates, emulsions, suspended concentrates and aerosol.

The wettable powders according to the invention can be prepared in such a way that they contain the active material, and they often or typically contain, in addition to a solid support, a wetting agent, a dispersant and, when necessary, one or more stabilizers and/or other additives, such as, for example, penetration agents, adhesives or anti-lumping agents, colorants etc.

Aqueous dispersions and emulsions, such as, for example, compositions comprising the compounds of this invention obtained by diluting with water a wettable powder or an emulsifiable concentrate are also included within the general scope of the invention. These emulsions can be of the water-in-oil type or of the oil-in-water type, and can have a thick consistency resembling that of a “mayonnaise”.

The compositions comprising the compounds of the present invention can contain other ingredients, for example protective colloids, adhesives or thickeners, thixotropic agents, stabilizersor sequestrants, as well as other active materials. A modest list of examples of possible formulation components for inclusion with the compositions of this invention follows without limitation.

### Carbon Skeleton/Energy (CSE) Components:

The supposed function of this component is to supply carbon skeleton for synthesis of proteins and other molecules or to supply energy for metabolism. Water-soluble carbohydrates such as sucrose, fructose, glucose and other di- and monosaccharides are suitable, commonly in the form of molasses or other by-products of food manufacture. Commercially available lignosulfonates, discussed below under the heading “Complexing Agents,” are also suitable as a CSE source inasmuch as they commonly contain sugars.

### CSE Components:

Sugar-mannose, lactose, dextrose, erythrose, fructose, fucose, galactose, glucose, gulose, maltose, polysaccharide, raffinose, ribose, ribulose, rutinose, saccharose, stachyose, trehalose, xylose, xylulose, adonose, amylose, arabinose, fructose phosphate, fucose-p, galactose-p, glucose-p, lactose-p, maltose-p, mannose-p, ribose-p, ribulose-p, xylose-p, xylulose-p, deoxyribose, corn steep liquor, whey, corn sugar, corn syrup, maple syrup, grape sugar, grape syrup, beet sugar, sorghum molasses, cane molasses, mineral salts lignosulfonate sugar alcohol-adonitol, galactitol, glucitol, maltitol, mannitol, mannitol-p, ribitol, sorbitol, sorbitol-p, xylitol xxxx acids-glucuronic acid, a-ketoglutaric acid, galacturonic acid, glutaric acid, gluconic acid, pyruvic acid, poly galacturonic acid, saccharic acid, citric acid, succinic acid, malic acid, oxaloacetic acid, aspartic acid.

Nucleotides and bases-adenosine, adenosine-p, adenosine-p-glucose, uridine, uridine-p, uridine-p-glucose, thymine, thymine-p, cytosine, cytosine-p, guanosine, guanosine-p, guanosine-p-glucose, guanine, guanine-p, NADPH, NADH, FMN, FADH

### The Macronutrient Components:

The macronutrients are essential to nutrition and growth. The most important macronutrients are N, P and K. Some example nitrogen compounds are: ammonium nitrate, monoammonium phosphate, ammonium phosphate sulfate, ammonium sulfate, ammonium phosphatenitrate, diammonium phosphate, ammoniated single superphosphate, ammoniated triple superphosphate, nitric phosphates, ammonium chloride, aqua ammonia, ammonia-ammonium nitrate solutions, mineral salts ammonium nitrate, mineral salts nitrate, mineral salts Cyanamid, sodium nitrate, urea, urea-formaldehyde, urea-ammonium nitrate solution, nitrate of soda potash, potassium nitrate, amino acids, proteins, nucleic acids.

Examples of phosphate sources include: superphosphate (single, double and/or triple), phosphoric acid, ammonium phosphate, ammonium phosphate sulfate, ammonium phosphate nitrate, diammonium phosphate, ammoniated single superphosphate, ammoniated single superphosphate, ammoniated triple superphosphate, nitric phosphates, potassium pyrophosphates, sodium pyrophosphate, nucleic acid phosphates and phosphonic and phosphorous acid derivatives.

The potassium ion for example can be found in: potassium chloride, potassium sulfate, potassium gluconate, sulfate of potash magnesia, potassium carbonate, potassium acetate, potassium citrate, potassium hydroxide, potassium manganate, potassium phosphate, potassium molybdate, potassium thiosulfate, potassium zinc sulfate and the like.

Mineral salts sources include for example: mineral salts ammonium nitrate, mineral salts nitrate, mineral salts Cyanamid, mineral salts acetate, mineral salts acetylsalicylate, mineral salts borate, mineral salts borogluconate, mineral salts carbonate, mineral salts chloride, mineral salts citrate, mineral salts ferrous citrate, mineral salts glycerophosphate, mineral salts lactate, mineral salts oxide, mineral salts pantothenate, mineral salts propionate, mineral salts saccharate, mineral salts sulfate, mineral salts tartrate and the like.

Magnesium can be found for example in: magnesium oxide, dolomite, magnesium acetate, magnesium benzoate, magnesium bisulfate, magnesium borate, magnesium chloride, magnesium citrate, magnesium nitrate, magnesium phosphate, magnesium salicylate, magnesium sulfate.

Sulfur containing compounds include for example: ammonium sulfate, ammonium phosphate sulfate, mineral salts sulfate, potassium sulfate, magnesium sulfate, sulfuric acid, cobalt sulfate, copper sulfate, ferric sulfate, ferrous sulfate, sulfur, cysteine, methionine and elemental sulfur.

### Micronutrient Components:

The most important micronutrients are or comprise: Zn, Fe, Cu, Mn, B, Co, and Mo.

### Vitamin/Cofactor Components:

The most important are folic acid, biotin, pantothenic idicotinic acid, iboflavin and thiamine and include for example: Thiamine-thiamine pyrophosphate, thiamine monophosphate, thiamine disulfide, thiamine mononitrate, thiamine phosphoric acid ester chloride, thiamine phosphoric acid ester phosphate salt, thiamine 1,5 salt, thiamine tri phosphoric acid ester, thiamine tri phosphoric acid salt, yeast, yeast extract Riboflavin-riboflavin acetyl phosphate, flavin adenine dinucleotide, flavin adenine mononucleotide, riboflavin phosphate, yeast, yeast extract. Nicotinic acid-nicotinic acid adenine dinucleotide, nicotinic acid amide, nicotinic acid benzyl ester, nicotinic acid monoethanolamine salt, yeast, yeast extract, nicotinic acid hydrazide, nicotinic acid hydroxamate, nicotinic acid-N-(hydroxymethyl)amide, nicotinic acid methyl ester, nicotinic acid mononucleotide, nicotinic acid nitrile. Pyridoxine-pyridoxal phosphate, yeast, yeast extract Folic acid-yeast, yeast extract, folinic acid. Biotin-biotin sulfoxide, yeast, yeast extract, biotin 4-amidobenzoic acid, biotin amidocaproate N-hydroxysuccinimide ester, biotin 6-amidoquinoline, biotin hydrazide, biotin methyl ester, d-biotin-N-hydroxysuccinimide ester, biotin-maleimide, d-biotin p-nitrophenyl ester, biotin propranolol, 5-(N-biotinyl)-3 aminoallyl)-uridine 5′-triphosphate, biotinylated uridine 5′-triphosphate, N-e-biotinyl-lysine. Pantothenic acid-yeast, yeast extract, coenzyme A, Cyanocobalamin-yeast, yeast extract. Phosphatidylcholine-soybean oil, eggs bovine heart, bovine brain, bovine liver, L-a-phosphatidylcholine, B-acetyl-g-O-alkyl, D-a-phosphatidylcholine (PTCn), B-acetyl-g-O-hexadecyl, DL-a-PTCh, B-acetyl-g-O-hexadecyl, L-a-PTCh, B-acetyl-g-O-(octadec-9-cis-enyl), L-a-PTCh, B-arachidonoyl, g-stearoyl, L-a-PTCh, diarachidoyl, L-a-PTCh, dibehenoyl (dibutyroyl, dicaproyl, dicapryloyl, didecanoyl, dielaidoyl, 12 diheptadecanoyl, diheptanoyl), DL-a-PTCh dilauroyl, L-a-PTCh dimyristoyl (dilauroyl, dilinoleoyl, dinonanoyl, dioleoyl, dipentadeconoyl, dipalmitoyl, distearoyl, diundecanoyl, divaleroyl, B-elaidoyl-a-palmitoyl, B-linoleoyl-a-palmitoyl) DL-a-PTCh di-O-hexadecyl (dioleoyl, dipalmitoyl, B—O-methyl-g-O-hexadecyl, B-oleoyl-g-O-hexadecyl, B-palmitoyl-g-O-hexadecyl), D-a-PTCh dipalmitoyl, L-a-PTCh, B—O-methyl-g-O-octadecyl, L-a-PTCh, B-(NBD-aminohexanoyl)-g-palmitoyl, L-a-PTCh, B-oleoyl-g-O-palmitoyl (stearoyl), L-a-PTCh, B-palmitoyl-g-oleoyl, L-a-PTCh, B-palmitoyl-a-(pyren 1-yl) hexanoyl, L-a-PTCh, B(pyren-1-yl)-decanoyl-g-almitoyl, L-a-PTCh, B-(pyren-1-yl)-hexanoyl-g-palmitoyl, L-a-PTCh, B-stearoyl-g-oleoyl. Inositol-inositol monophosphate, inositol macinate, myoinositol, epi-inositol, myo-inositol 2,2′ anhydro-2-c-hydroxymethyl (2-c-methylene-myoinositol oxide), D-myo-inositol 1,4-bisphosphate, DL-myo-inositol 1,2-cyclic monophosphate, myo-inositol dehydrogenase, myo-inositol hexanicotinate, inositol hexaphosphate, myo-inositol hexasulfate, myo-inositol 2-monophosphate, D-myo-nositol 1-monophosphate, DL-myo-inositol 1-monophosphate, D-myo-inositol triphosphate, scyllo-inositol PABA-m-aminobenzoic acid, O-aminobenzoic acid, p-aminobenzoic acid butyl ester, PABA ethyl ester, 3-ABA ethyl ester.

### Complexing Agents:

The function of this component, particularly in agricultural applications, aside from its proposed use as a Carbon skeleton agent, is to solubilize other components of the composition which otherwise may precipitate and become assailable or may immobilize minerals in the soil which might otherwise be unavailable to flora and fauna. Complexing agents such as, for example, citric acid, humic acids, lignosulfonate, etc. serve to tie up ions such as iron and prevent them from forming precipitates. In some cases this complexing is by way of chelation. These agents may form complexes with the following compounds for example: Citric acid; Ca, K, Na and ammonium lignosulfonates, fulvic acid, ulmic acid, humic acid, Katy-J, EDTA, EDDA (ethylenediaminedisuccinic acid), EDDHA, HEDTA, CDTA, PTPA, NTA, MEA, IDS, EDDS, and 4-phenylbutyric acid.

Other complexing agents include for example: Al and its salts, Zn-zinc oxide, zinc acetate, zinc benzoate, zinc chloride, zinc citrate, zinc nitrate, zinc salicylate, ziram Fe-ferric chloride, ferric citrate, ferric fructose, ferric glycerophosphate, ferric nitrate, ferric oxide (saccharated), ferrous chloride, ferrous citrate ferrous fumarate, ferrous gluconate, ferrous succinate. Mn-manganese acetate, manganese chloride, manganese nitrate, manganese phosphate, Cu-cupric acetate, cupric butyrate, cupric chlorate, cupric chloride, cupric citrate, cupric gluconate, cupric glycollate, cupric nitrate, cupric salicylate, cuprous acetate, cuprous chloride. B-mineral salts borate, potassium borohydride, borax, boron trioxide, potassium borotartrate, potassium tetraborate, sodium borate, sodium borohydride, sodium tetraborate and boric acid. Mo-molybdic acid, mineral salts molybdate, potassium molybdate, sodium molybdate, Co-cobaltic acetate, cobaltous acetate, cobaltous chloride, cobaltous oxalate, cobaltous potassium sulfate, cobaltous sulfate.

### Growth Regulators:

Seaweed extract-kelp extract, Kinetin, Kinetin riboside, benzyladenine, zeatin riboside, zeatin, extract of corn cockle, isopentenyl adenine, dihydrozeatin, indoleacetic acid, phenylacetic acid, IBA, indole ethanol, indole acetaldehyde, indoleacetonitrile, indole derivitives, gibberellins (e.g. GA1, GA2, GA3, GA4, GA7, GA38 etc.) polyamines, monoethanolamine, allopurinol, GA inhibitors, ethylene inducing compounds, ethylene biosynthesis inhibitors, GABA, nticytokinins and antiauxins, ABA inducers and inhibitors, and other known growth regulators.

### Gum Components:

Xanthan gum-guar gum, gum agar, gum accroides, gum arabic, gum carrageenan, gum damar, gum elemi, gum ghatti, gum guaiac, gum karya, locust bean gum, gum mastic, gum pontianak, gum rosin, gum storax, gum tragacanth Microbialstats Proprionic Acid, Benzoic Acid, Sorbic Acid and Amino Acids.

### Buffers

Phosphate buffer, formate or acetate buffer, AMP buffer, mineral salts tartrate, glycine buffer, phosphate citrate buffer, tris buffer, ECT.

If desired, a formulation or composition of the present invention may also include beneficial microorganisms. The compositions comprising the compounds of the present invention thus defined may be applied to plants by conventional methods including seed application techniques, as well as foliar methods.

The foregoing description of the invention has been directed in primary part to particular preferred embodiments in accordance with the requirements of the Patent Statutes and for purposes of explanation and illustration. It will be apparent, however, to those skilled in the art that many modifications and changes in the specifically described methods may be made without departing from the true scope and spirit of the invention.

One non-limiting example of such a modification would be the combining of an excess of one reactant to change the mole ratios increating urea lignin. Such a modification could be practiced by one of ordinary skill in the art from the teachings herein, and such practice would be within the true scope and spirit of the invention.

Therefore, the invention is not restricted to the preferred embodiments described and illustrated but covers all modifications, which may fall within the scope of the following claims.

I claim:

1. A fertilizer comprising amino lignin and/or amino lignincellulose.

2. The fertilizer of claim 1 further comprising of least one admix selected from the group comprising of: amino lignin, potassium amino lignin, amino lignincellulose, amino lignin phosphorous acid and support group comprising of organic or inorganic support material, surfactant, dispersant, wetting agents, protective colloids, adhesives, thickeners, thixotropic agents, stabilizers, sequestrants, carbon skeleton energy components, macronutrient components, micronutrient components, vitamin cofactor component, complexing agents, growth regulators, gum components, microbialstats, proprionic acid, benzoic acid, sorbic acid, amino acids, and buffers.

3. The fertilizer of claim 1 further comprising a solid admix such that the fertilizer is dry and soluble.

4. The fertilizer of claim 1 the fertilizer is a liquid.

5. The fertilizer of claim 4 wherein the fertilizer further comprises an admix.

6. The fertilizer of claim 1 wherein the amino lignin is prepared by the delignification of a biomass containing lignin utilizing urea or amino compounds at a temperature in the range of 0 degree C. to about 150 degree C. and the amino compounds are reacted with the biomass containing lignin in the range of 20% to 50% of amino compound to 50% to 80% biomass containing lignin by weight.

7. The fertilizer of claim 6 wherein the amino compound is urea.

8. The fertilizer of claim 6 where in the amino compounds are a mixture of urea with another amino compound.

9. The fertilizer of claim 2 wherein the amino lignincellulose is reacted with potassium hydroxide thereby producing potassium salt of amino lignin and lignincellulose.

10. The fertilizer of claim 6 consisting essentially of urea lignin and an admix wherein the fertilizer has potassium amino lignin as the potassium source and urea as the nitrogen source.

11. A method for enhancing plant growth comprising applying to plants, plant seeds, or soils, a liquid or a dry solid comprising amino lignin, amino lignin phosphorous acid, amino lignincellulose and potassium salt of amino lignin.

12. The method of claim 11 wherein the solid is water soluble and is mixed with an agricultural admix.

13. The method of claim 11 wherein the pH is buffered by a phosphorous acid or base.

14. The method of claim 11 wherein amino lignin, amino lignincellulose, and potassium salt of amino lignin by mixing, heating and reacting at ambient to elevated temperature, at ambient, elevated or reduced pressure, the following components:
a) biomass, comprising lignin containing plant material, in the amount of 200 to 400 parts by weight;
b) amino compound, selected from the group consisting of urea, guanidine, aminoguanidine, guanidine carbonate, urea guanidine condensates, urea polyamine condensates, urea-melamine condensates, urea-cyandiamide, urea-aminoguanidine condensate, urea cyanoguanidine condensate, and mixtures thereof, and urea combined with 50% by weight of thiourea, methyl urea, biuret, cyanuric acid, melamine dicyandiamide, melamine cyanurate and mixtures thereof, amino compounds are utilized in the amount of 25-100 parts by weight;
c) water, 1 to 500 parts by weight;
components a, b and c are mixed and reacted to produce a mixture of water soluble amino lignin and non-water soluble amino lignincellulose which are separated by pressing and filtering, then the following component d, e and f are added to the aqueous amino lignin;
d) potassium hydroxide, in the amount of 3 to 6 parts by weight is added and reacted with the amino lignincellulose thereby producing potassium salt of amino lignin, lignincellulose and cellulose;
d) acidic compound to adjust the pH, selected from the group consisting of sulfuric acid, hydrogen chloride, nitric acid, halogen acids, acidic compounds containing sulfur, sulphonic acid halides, acidic phosphorus containing compound, carboxylic acids, polycarboxylic acids, nitric acids, phosphorous acid and mixtures thereof in the amount of 0.1 to 100 parts by weight;

15. The method of claim 14 wherein the amino lignin and potassium salt of amino lignin are water soluble.

16. The method of claim 14 wherein the amino lignin, potassium salt of amino lignin, amino lignincellulose, lignincellulose and cellulose are dried into powder.

17. The method of claim 16 further comprising blending or reacting the reaction product with an admix for agricultural use.

18. The method of claim 17 further comprising spray drying the blended product.

19. The method of claim 18 further comprising packaging the product in solid form.

20. The method of claim 14 wherein the biomass which contains lignin containing plants comprising spruce, pine, hemlock, fir, oak, cypress, redwood, cherry, elm chestnut, hickory, locust, sycamore, tulip, tulip, butternut, apple, alder, magnolia, dogwood, catalpa, boxwood. Crabwood, mahogany, greenheart, lancewood, letterwood, mora, prima vera, purple-heart, rosewood, teak, satinwood, mangrove, waffle, orange, lemon, logwood, fustic, osage orange, sappanwood, Brazilwood, barwood, camwood, sandalwood, rubber, gutta, mesquite, oleander, cypress, junipers, acanthus, pyracantha, ligustrum, lantana, bougainvillea, azalea, feijoa, ilex, fuscia, hibiscus, datura, holly, hydrangea, jasmine, eucalyptus, cottoneaster, xylosma, rhododendron, castor gean, eugenia, euonymus, fatshedera, aralia, cotton stalks, corn stalks, wheat straw, oat straw, rice straw, cane sugar bagasse, soybean stalks, peanut plants, pea vines, sugar beat waste, sorghum stalks, tobacco stalks, maize stalks, barley straw, buckwheat straw, quinoa stalks, cassava, potato plants, legume vines and stalks, vegetable inedible portion, weeds, grasses, vines, kelp, flowers, paper, baggasse wallboard, wood products, grass clippings, switch grass humus, peat, soft brown coal and mixtures thereof, in the amount of 50 to 100 parts by weight.
